(19) United States
(12) Patent Application Publication
(10) Pub. No.: US 2008/0201016 A1
(43) Pub. Date: Aug. 21, 2008

(54) Robot and Method of Registering a Robot

(75) Inventor: Patrick Armstrong Finlay, Bucks (GB)

Correspondence Address: EGBERT LAW OFFICES, 412 MAIN STREET, 7TH FLOOR, HOUSTON, TX, 77002, US

(73) Assignee: PROSURGICS LIMITED, Bucks (GB)

(21) Appl. No.: 11/994,611

(22) PCT Filed: Jul. 6, 2006
(86) PCT No.: PCT/GB2006/002501

§ 371 Date: Jan. 3, 2008

(30) Foreign Application Priority Data
Jul. 6, 2005 (GB) 0513876.3

(51) Int. Cl. G05B 15/02

(52) U.S. Cl. 700/259; 901/2; 901/14; 901/47

(57) ABSTRACT

A robot has a controllable arm which carries an instrument or tool. The robot is provided with a camera to obtain an image of a work piece, including images of markers and an indicator present on the work piece. The robot processes the images to determine the position of the markers within a spatial frame of reference. The robot is controlled to effect predetermined movements of the instrument or tool relative to the work piece. The processor is further configured to determine the position of the indicator and to respond to movement of the indicator within the spatial frame of reference of the robot when the markers are concealed to determine a new position of the indicator and thus the new position of the work piece. Subsequently, the robot is controlled, relative to the new position of the work piece, to effect predetermined movements relative to the work piece.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a robot and relates to a method of registering a robot.

2. Description of Related Art Including Information Disclosed Under 37 CFR 1.97 and 37 CFR 1.98.

When a robot is to act on a work piece, it is necessary for the precise orientation and position of the work piece to be determined within the spatial frame of reference of the robot, so that the robot can operate accurately on the work piece, performing desired operations at precisely predetermined points on the work piece.

In many situations where robots are used, the robot is programmed to operate on a work piece of a precisely known size and shape, which is presented to the robot in a predetermined position relative to the robot. An example of such a situation is where a robot operates on a motor vehicle assembly line, where each work piece is of a precisely known size and shape, and is located in a precisely defined work station. In such a situation, the robot can be preprogrammed to carry out a sequence of moves which are appropriate for the task that the robot has to perform.

However, if the workpiece is not in a predetermined position before the robot can perform the operations, then it is necessary for the precise position and orientation of the work piece to be determined within the frame of reference of the robot before the robot can perform any moves relative to the work piece.

There are also situations where a robot has to perform tasks on a work piece where the size and shape and other characteristics of the work piece are known approximately, but the precise details differ from specimen to specimen. Examples may include hand made items, and items made of semi-rigid or deformable material, but a particular example is living tissue, for example, where the living tissue forms part of a patient, and where the robot is used in an operating theater to hold or guide specific instruments or other tools used by a surgeon.

When a robot is used in an operating theater, it is not uncommon for the task of the robot to involve the steps of penetrating the patient as the “work piece” in order to access a particular internal target or pathway. In many cases, the internal target or pathway is totally invisible from the surface of the work piece or patient, especially in the situation of a robot acting on a human patient in an operating theater. It is, however, essential that the robot should access the internal target or pathway accurately.

A convenient method which has been used for specifying appropriate co-ordinates and instructions to the robot for these types of tasks involves the use of an image guided technique. In utilizing this technique, an image is acquired of the work piece (which may be just one part of a patient, for example, the head of a patient) by using X-rays, magnetic resonance imaging, ultra-sound imaging or some other corresponding technique. The imaging technique that is utilized is chosen so that the internal target or pathway is revealed or can be determined.

So that there is a specific frame of reference which can be used to determine the absolute position of the internal target or pathway, a series of “markers” which will be visible within the generated image are mounted on the relevant part of the patient. The markers may be small metallic markers mounted on the head of the patient, for example.

An image of the relevant part of the patient is thus generated, and the image can be computer processed and displayed in a form that is convenient for a human operator. Depending upon the preference of the operator, and the nature of the internal target or pathway, the image may be presented as a series of “slices” through the work piece, or as three orthogonal views through a designated point, or, alternatively, as a three-dimensional reconstruction. There are many types of imaging processing algorithms available for this purpose.

Using an appropriate pointing device, such as a mouse, a human operator can now specify on the computer processed image of the relevant part of the patient where a target is located. The target may, for example, be a tumor. The operator may also indicate an appropriate approach path for the robot to reach the target. The target or required approach path are effectively defined relative to a frame of reference, which constitutes a set of three-dimensional spatial co-ordinates, but the positions of the markers are also defined with reference to the same frame of reference or the same spatial co-ordinates.

The co-ordinates of the key points of the desired approach path, and also the target itself are readily determinable from the pixel or voxel which the operator has specified with the pointing device.

Once the target and pathway have been defined, a series of instructions can be generated which can be utilized by the control arrangement of a robot so that the robot effects the appropriate moves to cause an instrument or end effector carried by the robot to follow the desired path to the target.

However, the instructions refer to the frame of reference of the images of the relevant part of the patient, and a robot will have its own “internal” frame of reference.

Thus, before the robot can be utilized to carry out the instructions provided by the robot controller, a “registration” process must be performed to “register” or correlate the internal frame of reference of the robot with the frame of reference of the images of the relevant part of the patient. In this way, it can be ensured that when the robot carries out the instructions, the instrument or end effector carried out by the robot actually follows the correct path and effects the appropriate movements.

It has been proposed to provide a robot and to register the position of the robot relative to an object, such as part of the patient (see WO 99/42257), by using a camera mounted on part of the robot which can acquire images of the markers used when initially preparing the computer processed image of the relevant part of the patient. Consequently, the camera on the robot can acquire images of the markers, and can determine the precise position of those markers within the internal frame of reference or internal spatial coordinates of the robot. However, because the position of the markers relative to the frame of reference or spatial co-ordinates used when the initial image was acquired are known, the frame of reference of the patient can be correlated with the frame of reference of the robot, and thus the precise coordinates of the target or path, as defined in the frame of reference of the images of the patient can easily be “translated” into the corresponding coordinates in the frame of reference of the robot, thus enabling the robot to follow the appropriate series of instructions.

When an arrangement of this type is utilized, it is conventional for the part of the patient to be operated on to be clamped firmly in position, and for the robot then to be calibrated, by effectively correlating the internal frame of reference of the robot with the frame of reference of the images of relevant part of the patient. Because the main part of the robot and the relevant part of the patient are both fixed firmly in position, the robot can then follow the prepared set of instructions, moving the instrument or end effector accurately in the predetermined manner.

However, should the relevant part of the patient move, then the robot may no longer be used, because there is no correlation between the frame of reference of the relevant part of the patient and the frame of reference of the robot. Correlation cannot be effected again at this stage because, typically, the relevant part of the patient has been draped with sterile drapes, rendering the markers invisible to the camera carried by the robot.

### BRIEF SUMMARY OF THE INVENTION

The present invention seeks to provide an improved robot and an improved method.

According to one aspect of this invention, there is provided a robot, the robot being provided with a controllable arm to carry an instrument or tool and a visual image acquisition device to obtain visual images of a work piece, including images of markers and an indicator present on the work piece. The robot incorporates a processor to process the images, the processor being configured to determine the position of the markers within a spatial frame of reference of the robot to determine the position of the work piece in the spatial frame of reference of the robot and to control the robot to effect predetermined movements of an instrument or tool carried by the arm relative to the work piece. The processor is further configured to determine the position of the indicator and to respond to movement of the indicator within the spatial frame of reference of the robot. When the markers are concealed, the new position of the indicator and thus the new position of the work piece are determined to subsequently control the robot to continue effecting the predetermined movements relative to the work piece.

Preferably the robot is configured to receive data in the form of or derived from one or more images of the work piece and the markers and information concerning the predetermined movements, the predetermined movements being defined within a frame of reference relative to the markers.

Conveniently the robot is for use by a surgeon, the controllable arm being adapted to carry a surgeon's instrument or tool.

Advantageously the robot is in combination with an arrangement provided with elements to engage the work piece to connect the arrangement to the work piece, the arrangement carrying said indicator.

Conveniently the indicator is removably connected to the arrangement.

Preferably the indicator has a head defining a planar face, the face being marked to indicate an axis passing across the face, the head being carried by a stem, the stem being received in a socket on the arrangement.

According to another aspect of this invention, there is provided a method of registering a work piece relative to a robot. The method comprises the steps of acquiring one or more images of a work piece, which incorporates visual markers, processing the images to identify at least one point on the work piece, generating control signals for a robot to define a path to be followed by a tool or instrument carried by the robot to bring the tool or instrument to the point, and providing the robot with an image acquisition device. The image acquisition device is used to acquire images of the markers, and a processor is utilized to process the images acquired with the image acquisition device and to control the robot to move the tool or instrument along the path. An indicator is provided, which has a predetermined spatial position relative to the markers, and processing, within the processor, the images from the image acquisition device, determines the position of the indicator. The markers are concealed, and the position is monitored by the indicator, responding to a movement of the indicator relative to the frame of reference of the robot by controlling the robot so that the tool or instrument continues to move along the path.

Conveniently, the indicator is removably mounted on an arrangement which is secured to the work piece. The method further comprises the steps of removing the indicator from the arrangement prior to the concealing of the markers, and replacing the indicator with an identical, but sterile, indicator following the concealing of the markers.

Advantageously, the concealing of the markers is effected by applying sterile drapes to the work piece.

Preferably the step of acquiring one or more images is accomplished by utilizing an X-ray or NMR or ultrasound apparatus.

Conveniently, the step of processing the images is accomplished by using a human operator to analyze the images and to use a pointer to identify the at least one point on the work piece.

### BRIEF DESCRIPTION OF THE SEVERAL VIEWS OF THE DRAWINGS

In order for the invention to be more readily understood, and so further features thereof may be appreciated, the invention will now be described, by way of example, with reference to the accompanying drawings.

FIG. 1 is a schematic view of a diagram of an apparatus for taking an image of a “work piece” in the form of the head of a patient.

FIG. 2 is a block diagram illustration.

FIG. 3 is a schematic view of a stereotactic frame provided with an indicator.

FIG. 4 is a schematic view of the stereotactic frame applied to the head of the patient.

FIG. 5 is a schematic view of the patient with the stereotactic frame and with the stereotactic frame secured to an operating table, the figure also illustrating a robot.

FIG. 6 is a schematic view similar to that of FIG. 5 showing an indicator mounted on the stereotactic frame.

FIG. 7 is a schematic view corresponding to FIG. 6, showing the patient when draped, with the indicator protruding.

FIG. 8 is a block diagram illustration.

FIG. 9 is a further block diagram illustration.

### DETAILED DESCRIPTION OF THE INVENTION

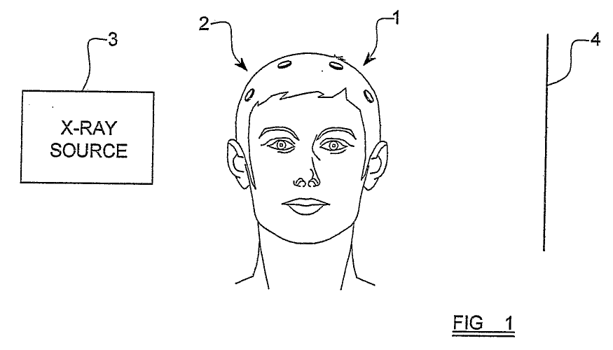

Referring initially to FIG. 1 of the accompanying drawings, a work piece, to be operated on with the aid of a computer controlled robot, is illustrated in the form of a human head 1. Mounted on the head are a plurality of markers 2. The markers are visible markers and are mounted on the exterior of the head so as to be readily seen. The markers, in this embodiment, are radio-opaque.

The head or work piece 1 is illustrated in position in an image acquisition apparatus between an x-ray source 3 and an x-ray sensitive screen 4. An x-ray image of the head can thus be taken, with the image including, of course, the radio-opaque markers 2.

It is envisaged that a plurality of images will be taken, with the work piece or head in different positions relative to the x-ray source and the screen, and this will enable the resultant set of images to be processed to produce a three-dimensional recreation of the work piece together with the markers, or three orthogonal images. Of course, the image-taking apparatus may be a CAT (Computerized Axial Topography) apparatus, producing a series of images equivalent to successive cross-sectional views or “slices”, and whilst the invention has been described thus far with reference to the taking of an x-ray image, it is to be appreciated that many other imaging techniques may be utilized, including NMR and ultrasound techniques.

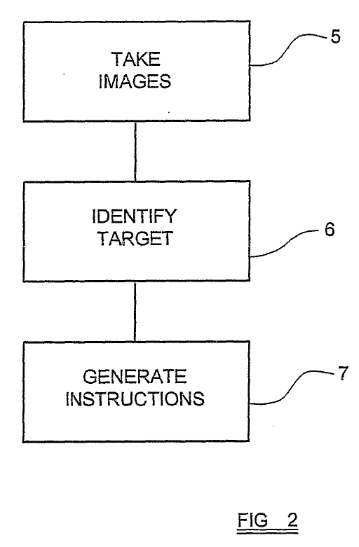

Referring now to FIG. 2, after a plurality of images have been taken, 5, the images are processed to identify a target within the human head 1. The target may, for example, be a tumor. The identification of the target, stage 6 as shown in FIG. 2, may be carried out by considering the plurality of images, and, optionally, by processing the images by computer. The target may be specifically identified, as described above, by a human operator using a pointer.

Subsequent to identification of the target, a series of instructions are generated 7 for a robot, the instructions indicating the desired path of travel of a tool or instrument carried by the robot. The instructions are generated to define predetermined movements of the tool or instrument carried by the robot in three-dimensional space, that three-dimensional space being identified by a frame of reference or set of spatial co-ordinates. The same frame of reference and set of spatial co-ordinates are used to determine the precise position of each of the markers 2. The instructions, thus, effectively, determine a particular predetermined movement of a tool or instrument relative to the markers 2.

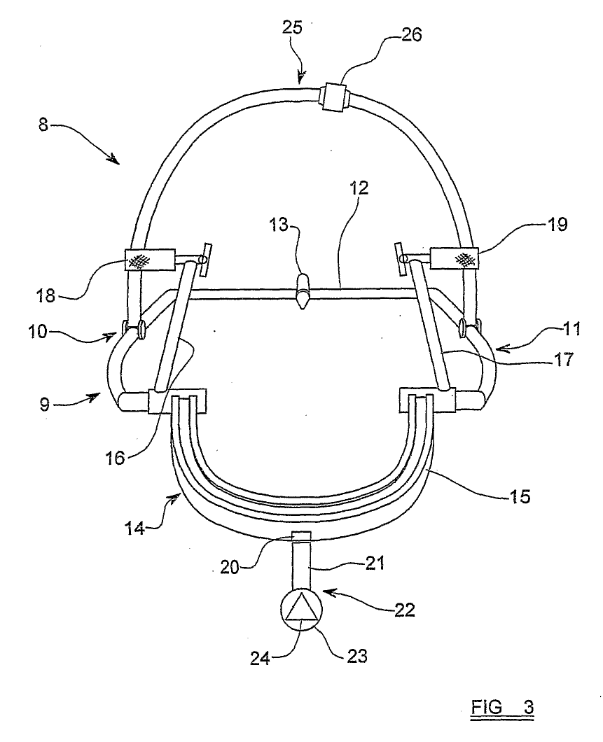

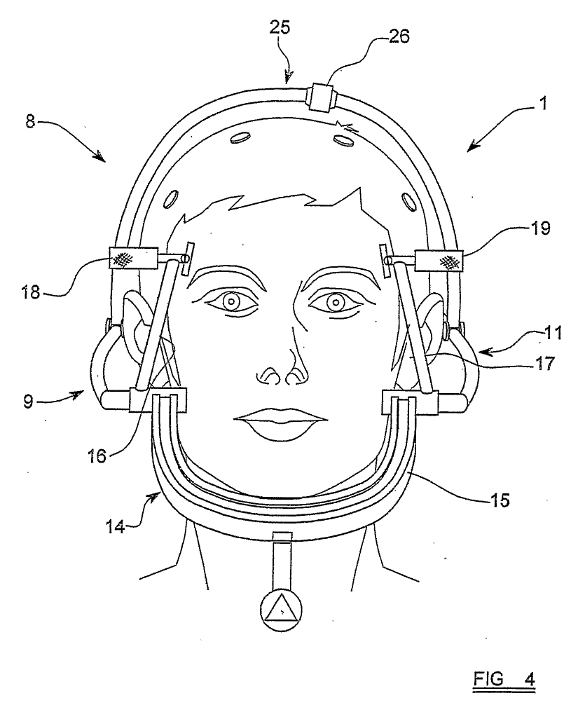

Subsequently the head of the patient is provided with a stereotactic frame. FIG. 3 illustrates a typical stereotactic frame although it is to be understood that many models of stereotactic frame exist.

Referring to FIG. 3, the illustrated stereotactic frame 8 is provided with a base ring 9 which is configured to be mounted over the head of the patient.

The base ring 9 comprises two substantially horizontal side arms 10, 11 which are interconnected by a rear bar 12. The rear bar 12 carries a mounting screw 13. The forward ends of the side arms 10 and 11 are interconnected by a yoke 14, the yoke 14 having a forward protruding U-shaped section 15 to be located in front of the jaw of the patient. The yoke is provided, at either side of the U-shaped section 15, with an upstanding arm 16, 17, each upstanding arm carrying, at its upper end, a mounting screw 18, 19.

The U-shaped yoke is provided with a socket 20 to receive the stem 21 of an indicator 22. The indicator 22 comprises a stem 21 and a head 23, the head 23 being provided with a marking 24, on a planar face of the head, to indicate an axis passing across the planar face to show the precise orientation of the head. As will be understood, the precise design of the indicator is not critical to the invention, but the indicator does need to be designed in such a way that by analyzing visual images of the indicator it is possible to determine the precise position and orientation of the indicator in three-dimensional space. In the described embodiment the indicator is removably connected to the stereotactic frame.

The illustrated stereotactic frame is provided with an arcuate half-hoop 25 which extends upwardly above the two side arms 10 and 11, the half-hoop 25 slidably supporting a tool carrier 26.

It is to be understood that when the indicator 22 is mounted in position on the stereotactic frame, the head 23 of the indicator has a precisely predetermined position, in three-dimensional space, relative to the rest of the stereotactic frame. Because the stereotactic frame is fitted relative to the head 1, and is thus fixed relative to the markers 2, the head 23 of the indicator 22 has a precisely determined spatial relationship with the markers 2. Thus it is possible, if the precise position and orientation of the head 23 of the indicator is known in a specific frame of reference, the position of the markers within that frame of reference can be easily determined even if the markers 2 are concealed.

It is to be appreciated that the stereotactic frame, as described above, is to be mounted on the head 1 of the patient, by placing the base ring over the head of the patient and subsequently tightening the mounting screws 13, 18 and 19 until they engage bony parts of the skull of the patient. The stereotactic frame is thus firmly mounted in position relative to the head of the patient.

The patient may then be placed on an operating table 30, and the stereotactic frame may be clamped to the operating table by an appropriate clamp 31. The stereotactic frame is thus securely fixed in position.

At this stage the markers 2 are visible.

A robot 40 is provided. The robot 40 comprises a housing 41 which is fixed in position and set in a predetermined spatial relationship with the stereotactic frame 8 which is clamped to the operating table 30. The housing 41 carries a vertical supporting column 42, the upper end of which pivotally supports an intermediate arm 43 which, in its turn, carries, at its free end, a pivotally mounted tool or instrument carrying arm 44. Mounted on the tool or instrument carrying arm 44 is a camera 45. The tool or instrument carrying arm 44 is illustrated carrying a tool or instrument 46. Of course, many different types of robots can be envisaged for use with the invention.

The camera 45 may be any form of camera such as a television camera, a digital camera, a CCD device or the like. The camera is adapted to acquire visual images of the head 1 of the patient and the markers 2 and, as will be described below, is also adapted to acquire visual images of the indicator 22.

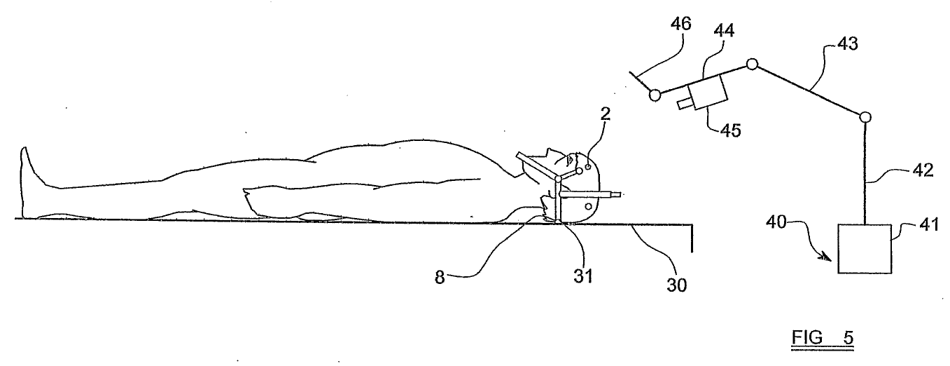

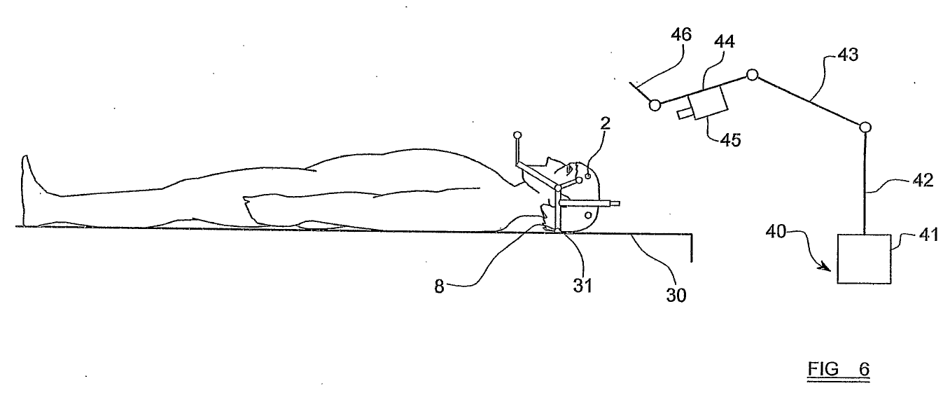

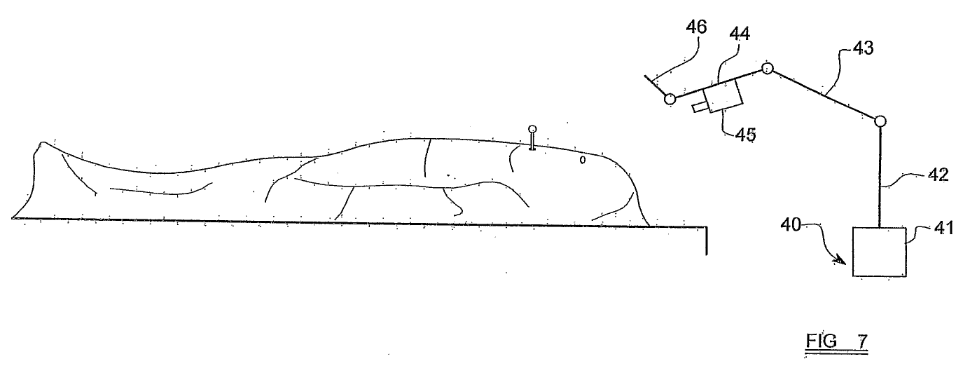

FIG. 6 is a view corresponding to FIG. 5 illustrating an indicator 22 mounted to the stereotactic frame. The head 23 of the indicator 22 has a predetermined spatial relationship with the head of the patient. FIG. 7 illustrates the situation that exists when the patient has been covered with sterile drapes; thus concealing the markers 2 but leaving a sterile indicator exposed.

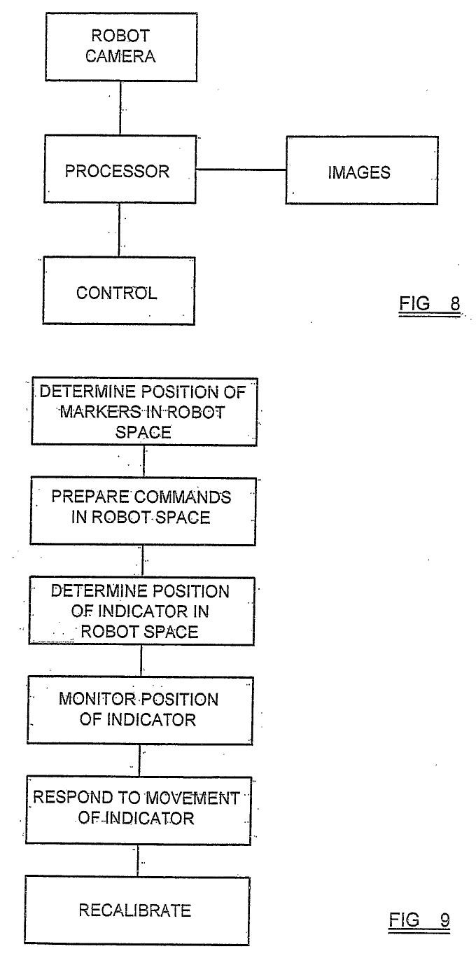

It is to be understood that when the patient is initially located on the operating table it is necessary to “register” the patient relative to the robot, so that the instructions that have been generated identifying the path to be followed by the tool or instrument carried by the robot can be “translated” into the frame of reference or spatial co-ordinates of the robot itself. Thus, initially, the camera 45 acquires images of the head 1, when the camera is in specific positions, and images from the camera are passed to a processor, as shown in FIG. 8. The processor 8 also receives images or data derived from the image acquisition apparatus of FIG. 1, and the processor effectively correlates the frame of reference utilized in the image acquisition apparatus of FIG. 1 with the frame of reference of the robot. The processor can thus pass signals to the control arrangement of the robot so that a tool or instrument carried by the instrument carrying arm 44 of the robot performs a desired manoeuver relative to the patient.

Referring now to FIG. 9, it is to be appreciated that the processor, on receiving images from the robot camera 45 effectively determines the position of the markers 2 in the frame of reference of the robot. Since the position of the markers is known, with regard to the frame of reference of the image acquiring apparatus, the processor can correlate the two frames of reference and can prepare appropriate commands in the robot's internal frame of reference.

The processor subsequently determines the position of the indicator 22, when the indicator has been mounted on the stereotactile frame, with regard to the internal frame of reference of the robot. Since the indicator 22 has a predetermined spatial relationship to the stereotactile frame, and thus also to the markers 2, the processor can determine the absolute spatial relationship between the indicator 22 and the frame of reference of the patient as utilized by the image acquisition device of FIG. 1.

Therefore, when the patient is covered (see FIG. 7) and the markers 2 are concealed from the view of the robot camera 45, the robot camera 45 can capture images of the indicator 22 (which is visible to the robot camera 45), and these images allow the processor to determine the position of the markers 2 in the frame of reference of the robot.

It will be appreciated that the processor is configured to determine the position of the indicator 22 and to respond to movement of the indicator 22 within the spatial frame of reference of the robot when the markers 2 are concealed to determine the new position of the indicator 22 and thus the new position of the patient. Subsequently, the processor can control the robot to continue effecting a predetermined movement relative to the patient based upon the new position of the patient.

It is to be appreciated that when the initial image of the indicator 22 is acquired, the indicator 22 may be a sterile indicator, appropriately mounted on the stereotactile frame before the patient is draped. The indicator may remain in place as the patient is draped leaving the sterile indicator protruding above the drapes which cover the patient.

Alternatively, however, the indicator that is utilized during the procedure illustrated in FIG. 6 may be a non-sterile indicator, and this may be removed, prior to draping to be replaced by a sterile indicator inserted through an appropriate opening in the sterile drapes, after the sterile drapes have been located in place. If this expedient is utilized, it is essential that the socket 20 in the stereotactile frame which receives the stem 21 of the indicator 22 should be such that the stem 21 of the indicator 22 can only be placed in the socket 20 in one particular orientation and with one particular degree of insertion. In such a way, a non-sterile indicator may be used for the acquisition of the image of the indicator by the camera 45 provided on the robot, and this indicator may be replaced by an absolutely identical, but sterile, indicator after the draping procedures have been completed. The head of the sterile indicator will then occupy exactly the same position, relative to the stereotactile frame, as the head of the non-sterile indicator.

The camera 45 will, as an operation is performed on the patient, continue to acquire images of the indicator. The processor is programmed to determine the position of the indicator within the frame of reference of the computer at regular intervals, and to determine if the indicator has moved. If the indicator has moved, as a consequence of an undesired movement of the head of the patient (or even as a consequence of a desired and required movement of the head of the patient), the processor, on receiving images of the indicator in its new position from the camera 45, is programmed to determine the absolute position of the indicator within the frame of reference of the robot when the markers 2 are concealed and, because the absolute spatial relationship between the indicator and the markers present on the head of the patient is known. The processor can effectively re-calibrate the robot, translating any instructions prepared on the frame of reference of the initial image acquisition device, as shown in FIG. 1, into appropriate instructions, within the frame of reference of the robot, having regard to the current position of the head of the patient.

Whilst the invention has been described with reference primarily to a work piece in the form of the head of a patient, it is to be appreciated that the invention may equally be used in connection with operations to be preformed on other parts of a patient, such as a knee or elbow or may be used on “work pieces” which are not part of a patient. Whilst the invention has been described with reference to a specific form of stereotactile frame, any appropriate form of retaining frame or clamp could be utilized.

The invention may be used during a surgical operation on a patient and the instrument 46 carried by the robot may be a surgical instrument.

When used in this Specification and Claims, the terms “comprises” and “comprising” and variations thereof mean that the specified features, steps or integers are included. The terms are not to be interpreted to exclude the presence of other features, steps or components.

The features disclosed in the foregoing description, or the following Claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A robot comprising:
a controllable having an instrument or tool carried thereon;
a visual image acquisition means to obtain visual images of a work piece, said visual images being comprised of images of markers and images of an indicator present on said work piece; and
a processor means for said visual images, said processor means determining a position of the markers within a spatial frame of reference to determine position of said work piece in said spatial frame and controlling said controllable arm in predetermined movements to affect said instrument or tool carried by the arm relative to said work piece, said processor means determining position of said indicator and responding to movement of said indicator within said spatial frame of reference when the markers are concealed, an alternate position of said indicator and thus an alternate position of said work piece being determined, said processor means controlling said controllable arm to continue effecting predetermined movements relative to said work piece.

2. A robot according to claim 1, wherein said processor means receives data from one or more images of said work piece and the markers and information concerning predetermined movements, said predetermined movements being defined within a frame of reference relative to the markers.

3. A robot according to claim 1, wherein said instrument or tool is comprised of a surgical tool.

4. A robot according to claim 1, further comprising:
an arrangement provided with elements to engage said work piece, said arrangement being connected to said work piece, said indicator being placed on said arrangement.

5. A robot according to claim 4, wherein said indicator is removably connected to said arrangement.

6. A robot according to claim 5, wherein said indicator has a head defining a planar face, said planar face being marked to indicate an axis passing thereacross, said head being carried by a stem, said stem being received in a socket on said arrangement.

7. A method of registering a work piece relative to a robot, said method comprising the steps of:
acquiring one or more images of a work piece, said work piece incorporating visual markers;
processing the images to identify at least one point on said work piece;
generating control signals for a robot to define a path to be followed by a tool or instrument carried by said robot to bring the tool or instrument to said at least one point;
providing said robot with an image acquisition device;
utilizing said image acquisition device to acquire images of the markers;
utilizing a processor to process the images acquired with said acquisition device and to control the robot to move the tool or instrument along said path;
providing an indicator with a predetermined spatial position relative to the markers;
processing, within the processor, the images from said image acquisition device to determine the position of the indicator;
concealing the markers;
monitoring position of the indicator; and
responding to a movement of the indicator relative to the frame of reference of the robot by controlling the robot so that the tool or instrument continues to move along said path.

8. A method of registering a work piece according to claim 7, wherein the indicator is removably mounted on an arrangement which is secured to the work piece, said method further comprising the steps of:
removing the indicator from said arrangement prior to concealing of the markers; and
replacing the indicator with an identical, but sterile, indicator following the concealing of the markers.

9. A method according to claim 7, wherein the concealing of the markers is comprised of applying sterile drapes to the work piece.

10. A method of registering a work piece according to claim 7, wherein the step of acquiring one or more images is comprised of utilizing an X-ray or NMR or ultrasound apparatus.

11. A method of registering a work piece according to claim 7, wherein the step of processing the images is comprised of using a human operator to analyze the images, and to use a pointer to identify said at least one point on the work piece.

12-14. (canceled)
